(19) United States
(12) Patent Application Publication
(10) Pub. No.: US 2008/0276172 A1
(43) Pub. Date: Nov. 6, 2008

(54) DYNAMIC MOUSE OVER HANDLING FOR TIGHTLY PACKED USER INTERFACE COMPONENTS

(75) Inventor: William G. Pagan, Durham, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/743,934

(22) Filed: May 3, 2007

(51) Int. Cl. G06F 3/048

(52) U.S. Cl. 715/711

(57) ABSTRACT

Embodiments of the present invention address deficiencies of the art in respect to mouse over sensitive user interface components and provide a novel and non-obvious method, system and computer program product for dynamic mouse over handling for tightly packed user interface components. In one embodiment of the invention, a method for dynamic mouse over handling for tightly packed user interface components can be provided. The method can include determining whether a mouse over enabled user interface component is tightly packed, and adding a delay to mouse over handling for the mouse over enabled user interface component if the mouse over enabled user interface component is determined to be tightly packed.

### BACKGROUND OF THE INVENTION

1. Field of the Invention

The present invention relates to the field of user interface event processing and more particularly to mouse over handling of user interface components.

2. Description of the Related Art

The conventional graphical user interface (GUI) has been widely used for many years. The primary function of the GUI includes providing user interface controls with which the end-user can interact with an underlying application. The common GUI includes many stock user interface controls, most of which, when combined, can accommodate most computer-human interactions required by an application. To that end, a menu bar control can provide a fixed, navigable textual menu for navigating the functionality of an application. By comparison, a context menu control can provide floating, navigable textual menu for the context sensitive navigation of the functionality of an application.

In an ideal environment, a large display space can accommodate a robust user interface in which multiple different GUI controls provide a fully navigable experience for the end user. The expansive nature of modern computing, however, has acted to complicate the typical GUI experience. Whereas in the past, the GUI reflected a relatively simple environment with few points of interaction, the modern GUI is rife with so many choices so as to overwhelm the end user in many circumstances. Case in point—cascaded menus such as the venerable “start” menu and other drop-up and drop-down menus with multiple nested menu items.

Cascaded menus generally include one or more selectable menu items and at least one additional cascade of menu items which also can include one or more selectable menu items and additional cascades of additional menu items and so forth. Cascaded menus can be found within traditional menu bars, as a standalone user interface element such as a “start” menu, or even as a context menu often activated through a “right click”. Many cascaded menus are mouse over sensitive. Generally speaking, a mouse over sensitive cascaded menu allows for the dynamic activation of a menu item or an additional cascade of menu items merely in response to detecting the proximity of a user interface pointing device such as a mouse, trackpoint, touchpad or pen.

Mouse over sensitive cascaded menus can be highly efficient as individual mouse clicks need not be required to activate a menu item or nested cascade of menu items. However, cascaded menus can be difficult to navigate when many different menu items and nested cascaded menus are provided in a single cascaded menu because display space can be limited and the mouse over sensitive nature of the very small space allotted to any one menu item cannot compare favorably to the largish size of the pointer in the user interface. In essence, since so many mouse-over sensitive areas can be crammed very closely together, very precise mouse movements will be required. Additionally, whereas a GUI layout may suffice for a display at one size, the same GUI layout may not suffice at a smaller display size where GUI components become tightly packed.

Precision in pointer movements, though, may not be possible for all users, such as those with impaired motor skills. The input device itself may also be imprecise such as is well known in the case of trackpoint and touchpad devices, for example. Even skilled users are impacted as there is a tendency to desire the navigation to be intelligent enough so as to allow the user to be somewhat lazy in their usage of a user interface. Activating a portion of a mouse over enabled component unintentionally due to the tightly packed nature of the GUI component can result in portions of the GUI component becoming obscured thereby degrading the usability of the GUI. Accordingly, what is needed is a more forgiving, yet equally accurate methodology for navigating through cascaded menus, or any user interface which contains tightly clustered mouse over sensitive user interface components.

### BRIEF SUMMARY OF THE INVENTION

Embodiments of the present invention address deficiencies of the art in respect to mouse over sensitive user interface components and provide a novel and non-obvious method, system and computer program product for dynamic mouse over handling for tightly packed user interface components. In one embodiment of the invention, a method for dynamic mouse over handling for tightly packed user interface components can be provided. The method can include determining whether a mouse over enabled user interface component is tightly packed, and adding a delay to mouse over handling for the mouse over enabled user interface component if the mouse over enabled user interface component is determined to be tightly packed.

In another embodiment of the invention, a user interface data processing system can be configured for dynamic mouse over handling for tightly packed user interface components. The system can include a user interface, user interface components disposed in the user interface, a mouse over event handler for one of the user interface components. a layout manager configured to identify a tightly packed mouse over enabled one of the user interface components, and tightly packed user interface component handling logic. The logic can include program code enabled to add a delay to mouse over handling for the identified tightly packed mouse over enabled user interface component.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a user interface configured for dynamic mouse over handling for tightly packed user interface components;

FIG. 2 is a schematic illustration of a user interface data processing system configured for dynamic mouse over handling for tightly packed user interface components; and,

FIG. 3 is a flow chart illustrating a process for dynamic mouse over handling for tightly packed user interface components.

### DETAILED DESCRIPTION OF THE INVENTION

Embodiments of the present invention provide a method, system and computer program product for dynamic mouse over handling for tightly packed user interface components. In accordance with an embodiment of the present invention, a tightly-packed mouse over sensitive user interface component can be configured to delay a response to a mouse over event in order to allow for precise pointer placement over a portion of the tightly packed mouse over sensitive user interface component. In this way, an unintended selection of a portion of the user interface component can be avoided in consequence of the proximity of the pointer to the portion of the tightly packed mouse over sensitive user interface component.

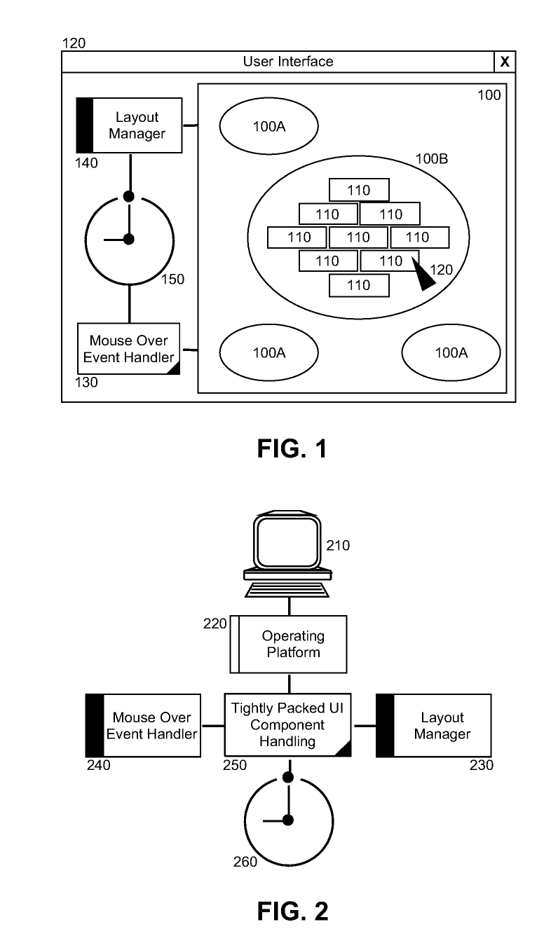

In illustration, FIG. 1 is a pictorial illustration of a user interface configured for dynamic mouse over handling for tightly packed user interface components. As shown in FIG. 1, a user interface 120 can include one or more user interface components 100, including both ordinarily packed user interface components 100A and tightly packed user interface components 100B. The tightly packed user interface components 100B (only a single tightly packed user interface component 100B shown for the sake of illustrative simplicity) can include multiple different selectable and activatable portions 110, each of which can be mouse over enabled and can include user interface elements specified within a markup language defined user interface such as imagery with defined hotspots or hyperlinks. In this way, the proximity of a pointer 120 to an activatable portion 110 can result in the selection and activation of the proximate portion 110 according to the logic of mouse over event handler 130.

A layout manager 140 further can be coupled to the user interface 120. The layout manager 140 can include program code enabled to determine the packedness of the components 100 and to identify tightly packed components 100B. For example, when multiple different portions 110 of a component 100B are positioned within a confined space to result in a high threshold ratio of portions 110 to available space in the component 100, the layout manager 140 can declare the presence of a tightly packed component 100B. In consequence, logic of the mouse over event handler 130 can be extended to provide for a delay 150 before triggering the event handler in response to the detection of the proximity of the pointer 120 to a portion 110 of the tightly packed mouse over enabled user interface component 100B.

In further illustration, FIG. 2 is a schematic illustration of a user interface data processing system configured for dynamic mouse over handling for tightly packed user interface components. The system can include a computing device 210, for instance a personal computer or pervasive computing system such as a personal digital assistant or cellular telephone. An operating platform 220 can be provided for the computing device 210 and can include an operating system or network distributable operating environment. Notably, the operating platform 220 can include a library of user interface components and logic enabled to generate a user interface in behalf of an executing application.

A mouse over event handler 240 can be coupled the operating platform 220. The mouse over event handler 240 can include operational code sections programmed to execute logic conditionally upon the detection of a proximity event of a pointer such as a mouse pointer to a portion of a mouse over enabled user interface component such as a cascaded menu item. A layout manager 230 also can be coupled to the operating platform 220 and can include logic programmed to detect the presence of mouse over enabled user interface components. Importantly, the logic of the layout manager 230 can be programmed to compute a packedness of a mouse over enabled user interface component.

To the extent the logic of the layout manager 230 computes a packedness exceeding a threshold level, a tightly packed mouse over enabled user interface component can be determined and tightly packed user interface component handling logic 250 can be invoked. In particular, the tightly packed user interface component handling logic 250 can include program code enabled to impose a delay according to coupled clock 260 before permitting the activation of the mouse over event handler 240 for a tightly packed mouse over enabled user interface component in response to detecting the proximity of a pointer to the tightly packed mouse over enabled user interface component. In this way, should the pointer stray from proximity before the expiration of the delay, the logic of the mouse over event handler 240 will not trigger for the transient proximity of the pointer to the tightly packed mouse over enabled user interface component.

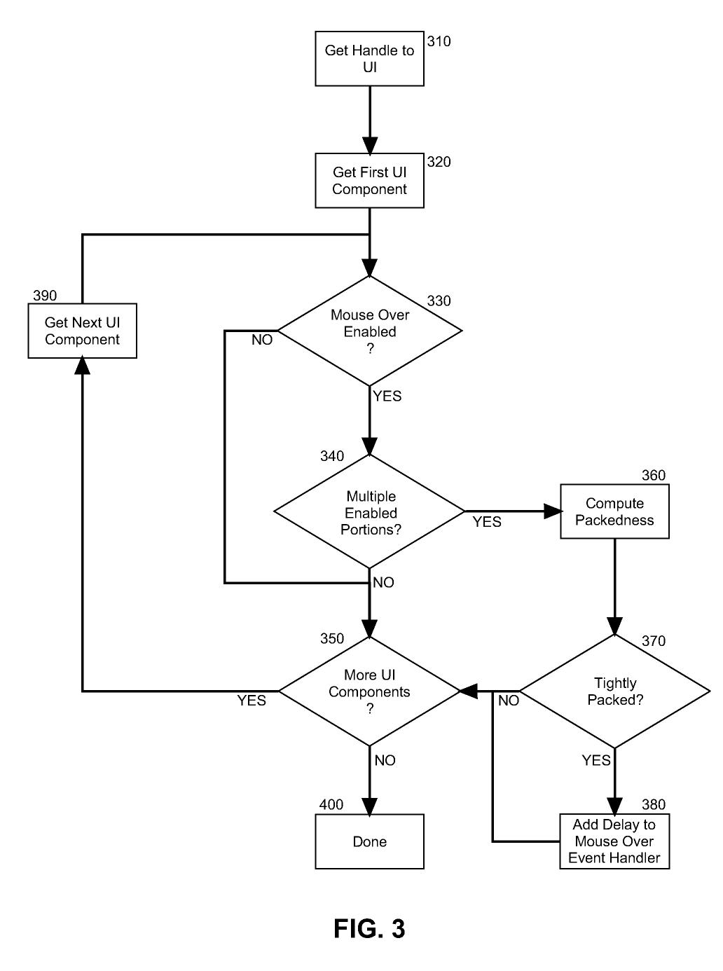

In yet further illustration, FIG. 3 is a flow chart illustrating a process for dynamic mouse over handling for tightly packed user interface components. Beginning in block 310, a handle to a user interface can be retrieved and in block 320, a first user interface component in the user interface can be selected for processing. In decision block 330, it can be determined whether the selected user interface component has been mouse over enabled. If so, in decision block 340, it further can be determined whether multiple different portions of the user interface control have been enabled for mouse over event handling. If not, in decision block 350 if additional user interface components remain to be processed, in block 390 a next user interface component in the user interface can be selected for processing. Otherwise, the process can continue through block 360.

In block 360, a packedness for the selected user interface component can be determined. In particular, the density of the user interface component resulting from the number of portions of the user interface component which are separately mouse over enabled in single user interface component can be computed. In decision block 370, if the density exceeds a threshold value, a tightly packed mouse over enabled user interface component can be determined and in block 380, a delay can be added to the mouse over event handler for the user interface component to allow for more precise pointer control in respect to the user interface component. The process can repeat for each other user interface component in the user interface before the process terminates in block 400.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for dynamic mouse over handling for tightly packed user interface components, the method comprising:
determining whether a mouse over enabled user interface component is tightly packed; and,
adding a delay to mouse over handling for the mouse over enabled user interface component if the mouse over enabled user interface component is determined to be tightly packed.

2. The method of claim 1, wherein determining whether a mouse over enabled user interface component is tightly packed, comprises comparing a number of mouse over enabled portions of the user interface component to display space allocated to the user interface component to determine a density and whether the density exceeds an acceptable threshold value.

3. A user interface data processing system configured for dynamic mouse over handling for tightly packed user interface components, the system comprising:
a user interface;
a plurality of user interface components disposed in the user interface;
a mouse over event handler for one of the user interface components;
a layout manager configured to identify a tightly packed mouse over enabled one of the user interface components; and,
tightly packed user interface component handling logic comprising program code enabled to add a delay to mouse over handling for the identified tightly packed mouse over enabled user interface component.

4. The system of claim 3, wherein the tightly packed mouse over enabled one of the user interface components is a tightly packed cascaded menu.

5. The system of claim 3, wherein the tightly packed mouse over enabled one of the user interace components is a hotspot enabled image in a markup language defined user interface.

6. The system of claim 3, wherein the tightly packed mouse over enabled one of the user interace components is a hyperlink in a markup language defined user interface.

7. The system of claim 4, wherein the tightly packed cascaded menu is a start menu.

8. The system of claim 4, wherein the tightly packed cascaded menu is a context menu.

9. The system of claim 4, wherein the tightly packed cascaded menu is a menu item from a menu bar.

10. A computer program product comprising a computer usable medium embodying computer usable program code for dynamic mouse over handling for tightly packed user interface components, the computer program product comprising:
computer usable program code for determining whether a mouse over enabled user interface component is tightly packed; and,
computer usable program code for adding a delay to mouse over handling for the mouse over enabled user interface component if the mouse over enabled user interface component is determined to be tightly packed.

11. The computer program product of claim 10, wherein the computer usable program code for determining whether a mouse over enabled user interface component is tightly packed, comprises computer usable program code for comparing a number of mouse over enabled portions of the user interface component to display space allocated to the user interface component to determine a density and whether the density exceeds an acceptable threshold value.
